(19) United States
(12) Patent Application Publication
(10) Pub. No.: US 2018/0287641 A1
(43) Pub. Date: Oct. 4, 2018

(54) SOUND AMPLIFICATION

(71) Applicant: Ian Brown, Jurupa Valley, CA (US)

(72) Inventor: Ian Brown, Jurupa Valley, CA (US)

(21) Appl. No.: 15/940,326

(22) Filed: Mar. 29, 2018

Related U.S. Application Data
(60) Provisional application No. 62/478,578, filed on Mar. 29, 2017.

(51) Int. Cl. H04B 1/034; H04B 15/00

(52) U.S. Cl. CPC H04B 1/0346; H04B 15/005

(57) ABSTRACT

A cupped structure formed by walls having a cup shape are fastened to a radio to surround at least the speaker area of the radio with the walls. The sound is allowed to exit the radio through cupped structure. The sound exiting the cupped structure is amplified.

### CROSS REFERENCE TO RELATED APPLICATIONS

This application claims priority benefit of U.S. Provisional Patent Application No. 62/478,578 (Docket Number CR-1), entitled “SOUND AMPLIFICATION FOR A RADIO,” filed on Mar. 29, 2017, by Ian Brown, which is incorporated herein by reference.

### FIELD

This specification generally relates to a handheld radio for personal communication.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in-and-of-themselves may also be inventions.

Two-way radios are known. Two-way radios may need to be used in noisy environments, such as in the locomotive of a train or by the operator of heavy equipment, such as tractors, wrecking balls, and cranes. The operators of the equipment may need guidance from those that are closer to a particular event or for other reasons have a better view or have more information related to one or more consequences of the operations of the equipment. Consequently, it may be important that the operator of the heavy equipment, be able to hear a two-way radio, via which the operator of the equipment receives communications from another worker that is monitoring the effects of the operations. However, due to the noise of the environment, the operator may not hear the two-way radio, and not know to stop or alter the operations currently in progress. For example, a train operator may run a red light, if the red light is not visible soon enough and the train operator does not hear his/her two-way radio. Similarly, if the operator of a wrecking ball cannot hear his/her two-way radio, the operator of the wrecking ball may allow the wrecking ball to hit a building despite frantic attempts to tell the operator of the wrecking ball that a person or pet has innocently wondered into an area that was cordoned off, because of the danger of falling debris from the wrecking ball hitting the building.

Although one may be able to equip the operator with radios that have a larger volume, radios with a larger volume may not necessarily be available to the equipment operators.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows a front, right, perspective view of an embodiment of a radio with a sound amplifier attached.

FIG. 2 shows another view of the radio with the sound amplifier from a left, front perspective.

FIG. 3 shows a left side view of the radio with the sound amplifier.

FIG. 4 shows a view of the bottom of the sound amplifier, which is the bottom of the sound amplifier.

FIG. 5 shows a right, front, perspective view of the sound amplifier, unattached to the radio.

FIG. 6 shows the front, top, left view of the sound amplifier.

FIG. 7 shows a right-side view of the sound amplifier.

FIG. 8 shows a front, right, perspective view of an embodiment of a microphone with a sound amplifier attached.

FIG. 9 shows another view of the microphone with the sound amplifier from a left, front perspective.

FIG. 10 shows a back side view of the microphone with the sound amplifier.

FIG. 11 shows a view of the left side of the microphone.

FIG. 12 shows a top view of the microphone with the sound amplifier

FIG. 13 shows a view of the back of the sound amplifier.

FIG. 14 shows a perspective view of the front of the sound amplifier.

FIG. 15 shows a view of the front of the sound amplifier.

FIG. 16 shows another perspective view of the front of the sound amplifier.

FIG. 17 shows a view of the back of the sound amplifier.

FIG. 18 shows a view of the right of the sound amplifier (in an embodiment, the left side is a mirror image of the right side).

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

In an embodiment, an amplifier, such as a bull horn is attached to the speaker area of a radio, so that the radio sounds louder and can still be heard in noisy environments. In this specification, the word “radio” is generic to a two-way radio, a walkie talkie and a mobile phone.

In an embodiment, a conduit that guides sounds exiting from the radio concentrating the sound in a particular direction is attached to the radio. The conduit is attached to at least one fastener that fastens the conduit to the radio. Optionally, a casing encloses the radio so as to block other sounds from the radio and/or so as to concentrate the sounds from the radio, so as to leave the casing through the conduit, and the amplifier is attached to the casing. The conduit may be placed in a speaker region of the radio, which has slits, so as to allow sound to escape the speaker region, which is surrounded by walls to form a cup like region on the exterior of the casing. The conduit may be formed by a wall forming a cupped region that is open at two ends.

The speaker of the radio aligns with the cupped area, which has an opening surrounding the slots covering the speaker to allow the sound to enter and exit the casing. The user may either speak into the cupped area, thereby speaking into the speaker of the radio, or optionally, puts his/her ear to the cupped area to hear sounds coming from the radio. If the user is not expecting a communication at the time a communication is received, the cupped area may still create a bull horn/megaphone effect, amplifying the volume and helping the user hear the communication. The flanges that form the cup on the cupped area are shaped to act in a manner similar to a bull horn, and also block out at least some of the noise, so that the user can more easily talk into the radio with the radio near the user's mouth and listen to the radio with the radio near the user's ear. Optionally, the speaker and the microphone of the radio both align with the opening in the amplifier and are both surrounded by the cupped region.

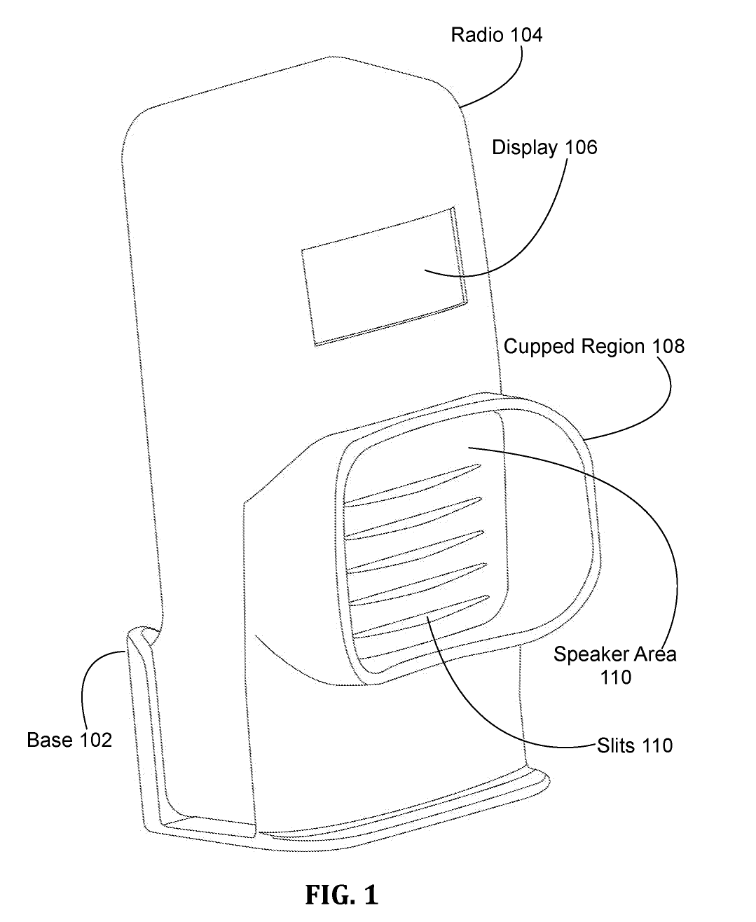

FIG. 1 shows a front, right, perspective view of an embodiment of the radio with the amplifier attached. The radio has a display, via which the text messages may be seen (in an embodiment in which the radio is enclosed in a casing to which the amplifier is attached, the casing has a window that aligns with the display of the radio). In the embodiment of FIG. 1, the amplifier is one integral part that snaps onto one end of the radio, which may be the bottom of the radio. As, alluded to above, the amplifier has a cupped region for focusing sound and the slits of the radio are surrounded by the walls of the cupped region amplifying the sound exiting from the radio. In an embodiment, one can also speak into the cupped region to talk into the radio.

In the embodiment of FIG. 1, the speaker is at the bottom of the radio and the amplifier is attached to the bottom of the radio. In the embodiment of FIG. 1, the cupped region is attached to the amplifier, such that the slits of the speaker of the radio are surrounded by the walls of the cupped area of the radio.

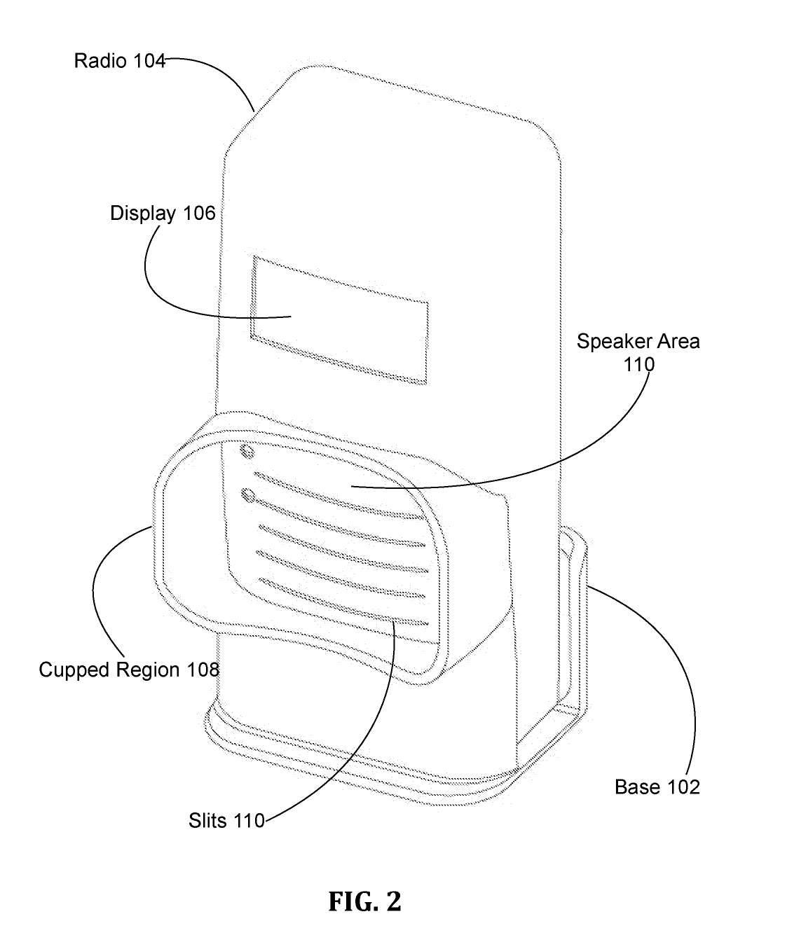

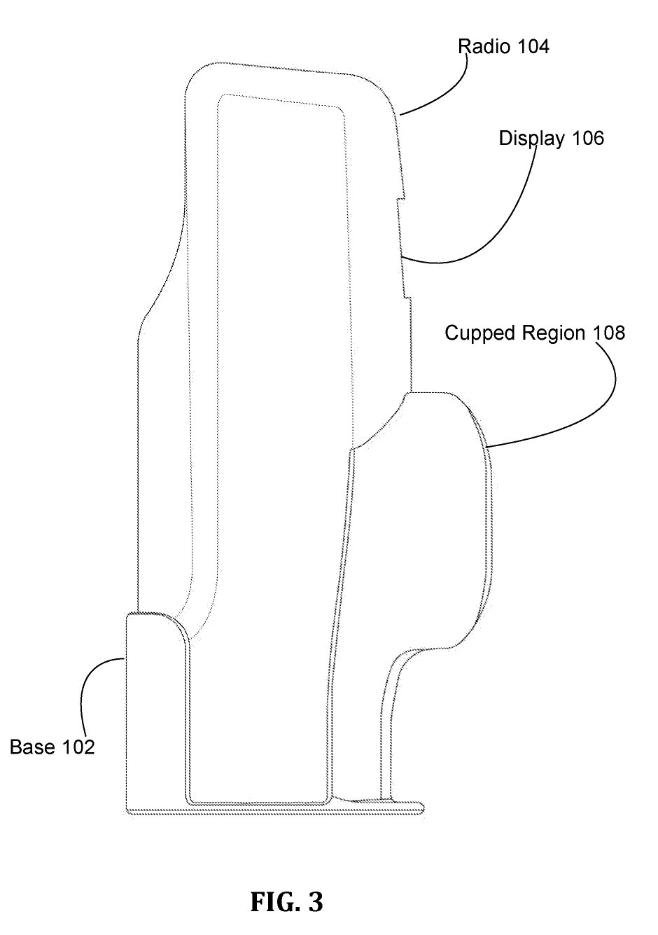

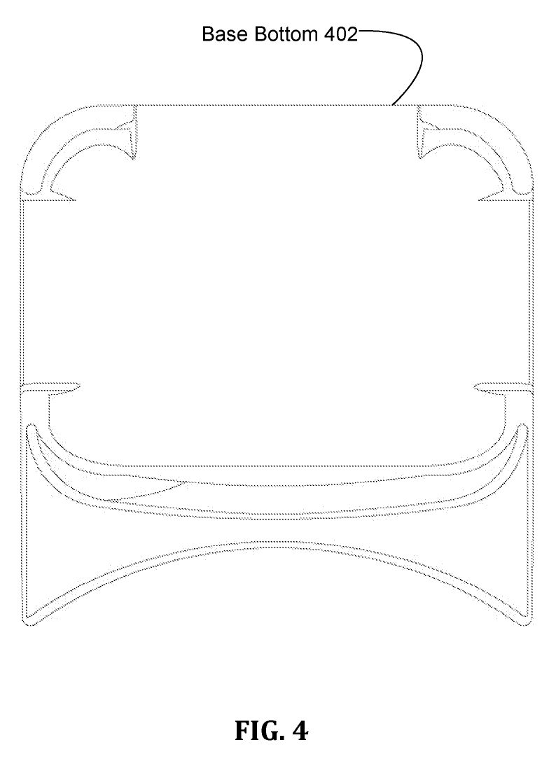

FIG. 2 shows another view of the radio and amplifier from a left, front perspective. FIG. 3 shows a left side view of the radio and amplifier. In an embodiment, the left side view of the radio with the amplifier attached is a mirror image of the right side view of the radio with amplifier attached. FIG. 4 shows a view of the bottom of the amplifier, which is the base of the amplifier.

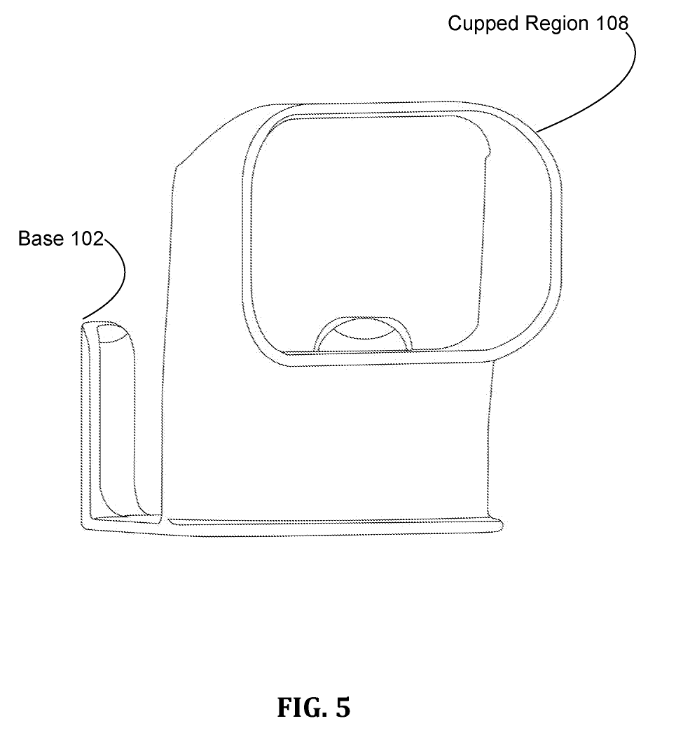

FIG. 5 shows a right front perspective view of the amplifier, unattached to the radio. FIG. 5 shows that the two arms in the back of the amplifier that extended upwards, perpendicularly from the bottom/base of the amplifier at the back of the amplifier. In the front of the base of the amplifier is a wall perpendicular to, and attached to, the front edge of the bottom of the amplifier. The front wall supports the walls that form the cupped region. In an embodiment of FIG. 5, the walls of the cupped region form a rectangular conduit (which optionally has rounded corners). In an embodiment, the arms and front wall help guide the amplifier onto the bottom of the radio. The arms and front wall are contoured to the fit the contour of the outer casing of the radio, so as to snuggly fit over the bottom of the radio and the amplifier may be held on to the radio by friction caused by the arms, front wall and/or cupped region. Optionally, the arms and/or front wall include tabs or protrusions that interlock with indentations in the casing of the radio and/or indentations that interlock with tabs or protrusions on the radio (in an embodiment in which the radio is placed in an enclosure, the arms and/or front wall include tabs or protrusions that interlock with indentations in the enclosure that covers the radio and/or indentations that interlock with tabs or protrusions on the enclosure that covers the radio).

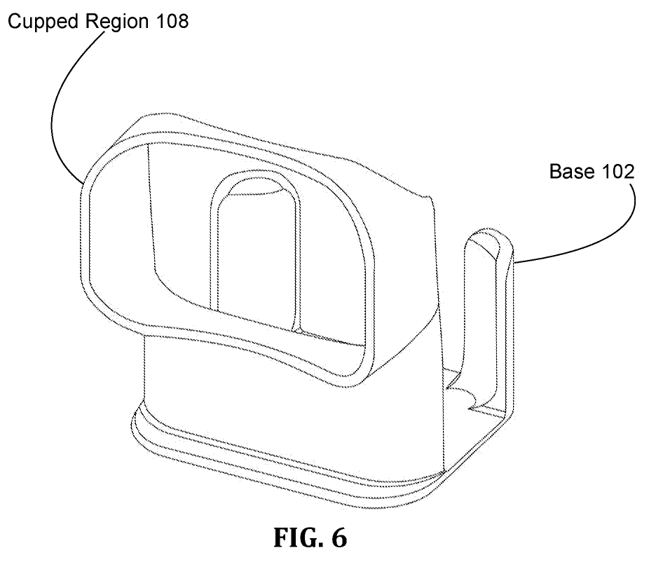

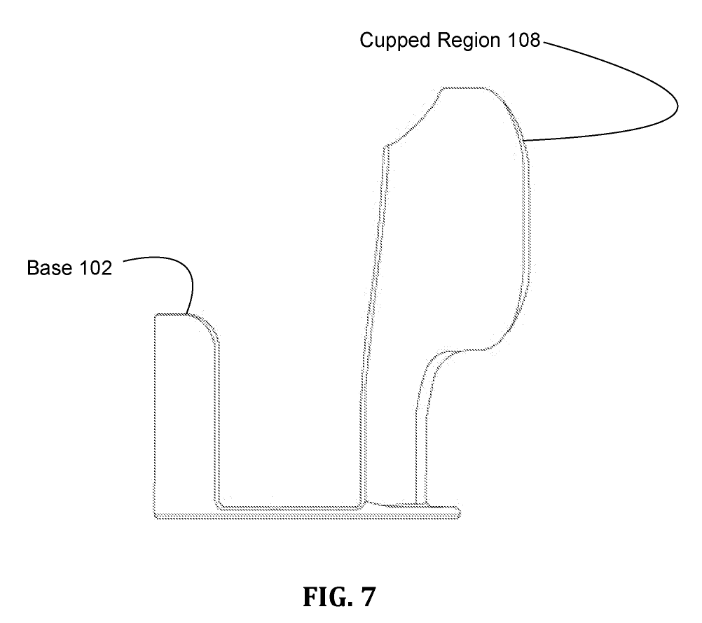

FIG. 6 shows the front, top, left view of the amplifier. FIG. 7 shows a right side view of the amplifier. In an embodiment, the right side view of the amplifier is a mirror image of the left side view of the amplifier (which may be the same embodiment in which the right side view of the radio is a mirror image of the left side view of the radio).

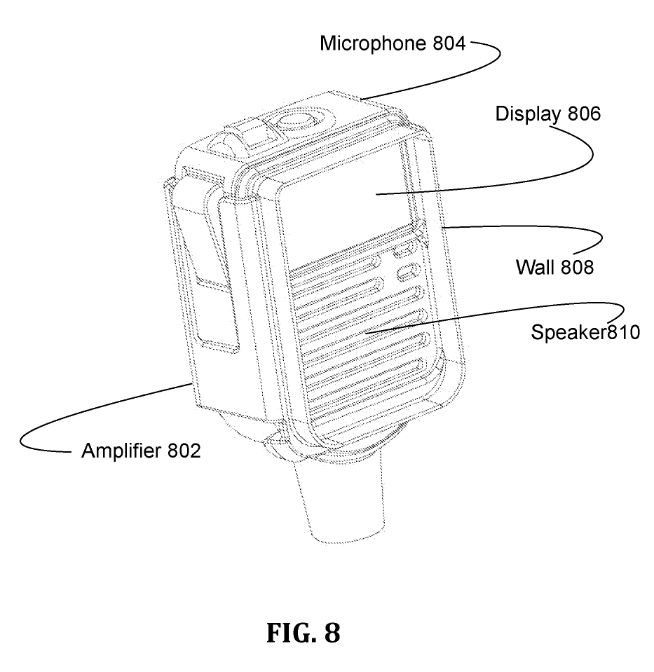

FIG. 8 shows a front, right, perspective view of an embodiment of a microphone with another embodiment of the amplifier attached. In the embodiment of FIG. 8, the amplifier may be one integral part that snaps onto one end of the microphone, which may be the bottom and/or sides of the microphone. The amplifier for the microphone also has a cupped region that focusing sound and the slits of the microphone are surrounded by the walls of the cupped region amplifying the sound exiting from the radio. In an embodiment, one can also speak into the cupped region to talk into the microphone.

In the embodiment of FIG. 8, the speaker is at the bottom of the microphone and the amplifier is attached to the sides of the microphone by clipping on. In the embodiment of FIG. 8, the cupped region is attached to the amplifier, such that the slits of the speaker of the radio are surrounded by the walls of the cupped area of the radio.

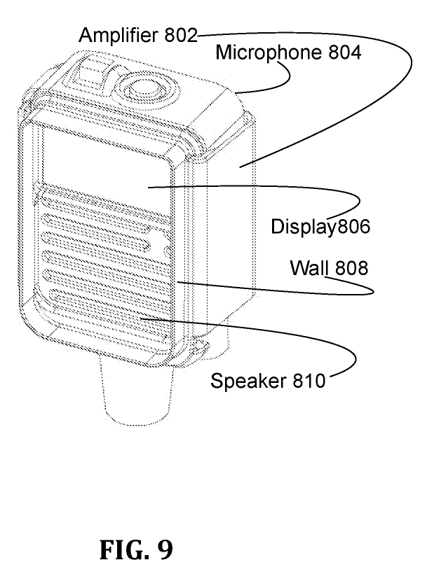

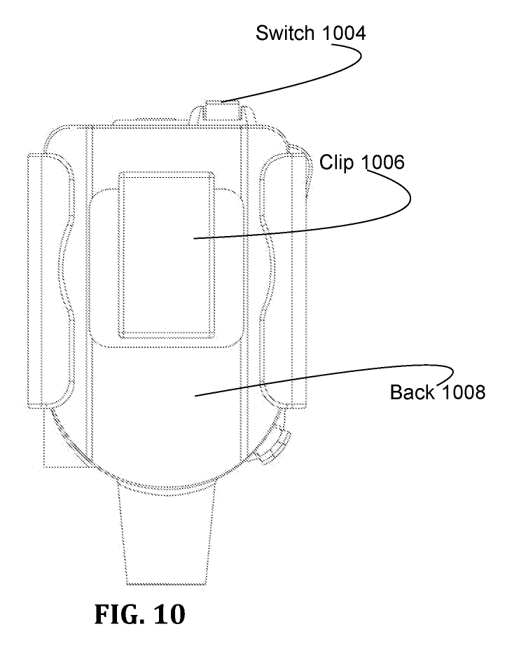

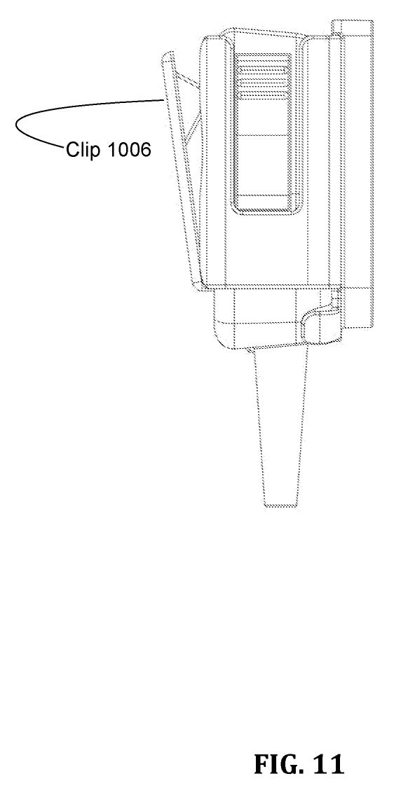

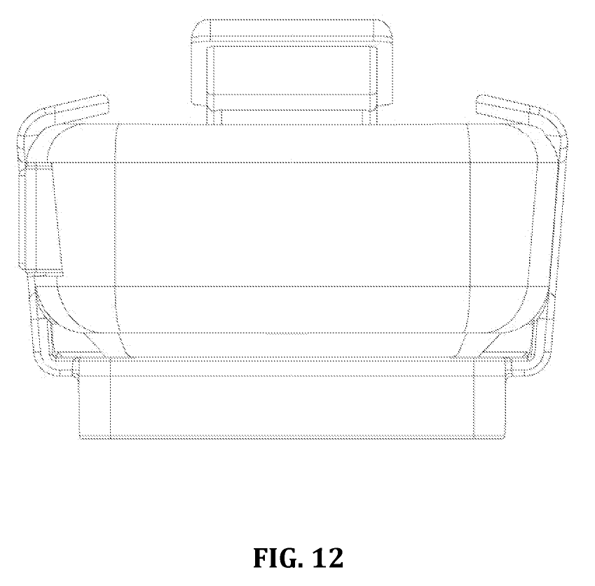

FIG. 9 shows another view of the radio and amplifier from a left, front perspective. FIG. 10 shows a left side view of the radio and amplifier. In an embodiment, the left side view of the radio with the amplifier attached is a mirror image of the right side view of the radio with amplifier attached. FIG. 11 shows a view of the side of the amplifier and microphone. FIG. 12 shows a bottom view of the amplifier attached to the radio. FIG. 12 shows that the two arms of the amplifier. The side walls extend around the back of the microphone to hold the amplifier in place. The side walls, the extension of the side walls, and front wall are contoured to the fit the contour of the outer casing of the microphone, so as to snuggly fit the radio and the amplifier may be held on to the radio by friction caused by the arms, front wall, and/or cupped region.

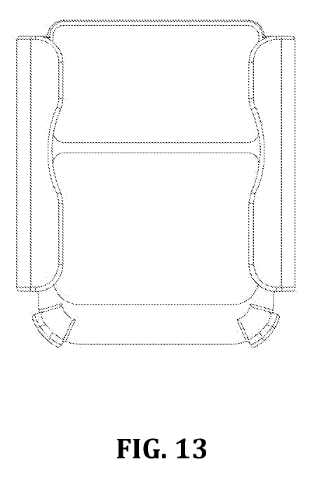

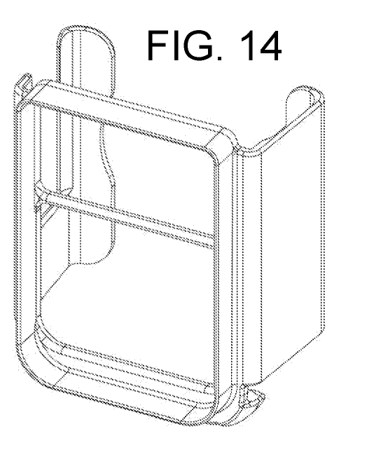

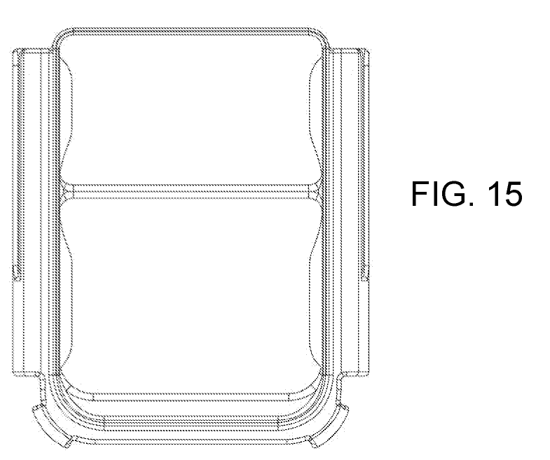

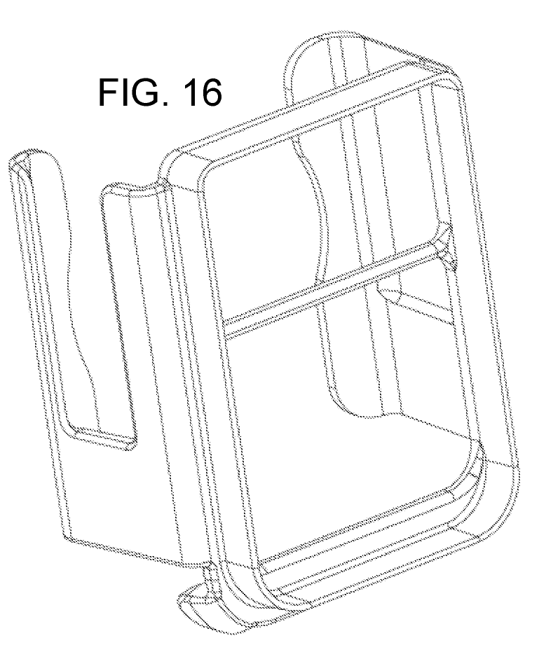

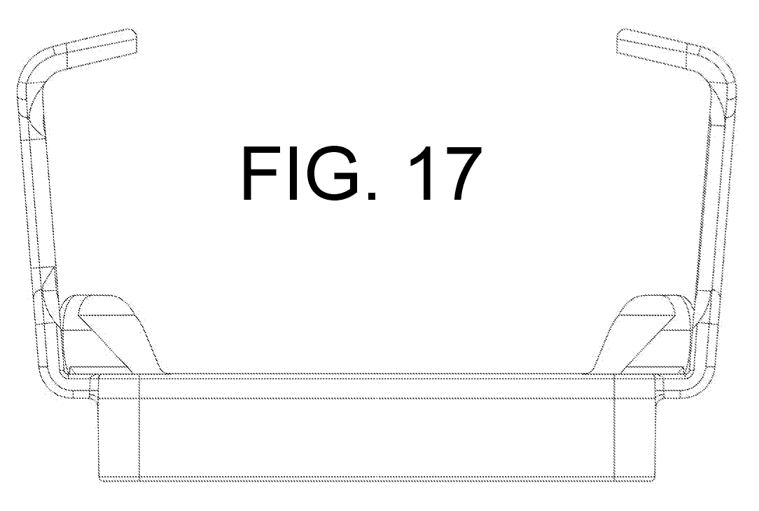

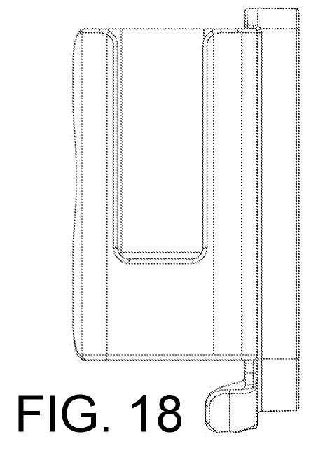

FIG. 13 shows the bottom of the amplifier, which is the base of the amplifier. FIG. 14 shows a perspective view of the front of the sound amplifier. FIG. 15 shows a view of the front of the sound amplifier. FIG. 16 shows another perspective view of the front of the sound amplifier. FIG. 17 shows a view of the back of the sound amplifier. FIG. 18 shows a view of the right of the sound amplifier (in an embodiment, the left side is a mirror image of the right side). The Amplifier for the microphone is open on the bottom, so as not to interfere with the cord of the microphone. The Amplifier for the microphone is open on the top and on one sides, so as not to interfere with a switches of the microphone for controlling the microphone. The Amplifier for the microphone is open in the back, so as not to interfere with the clip of the microphone (the clip allows the microphone to be attached to one's clothing, to be hung up when not in use, or to another object.

In an embodiment, the front wall, the base of the amplifier, and the arms form a fastener that fastens the cupped region to the radio.

In an embodiment, the cupped area helps prevent wind from disrupting radio communications. In addition to being useful in trains, the cupped area may be useful in windy environments or work environments that require a worker to be on the move whether on foot or in a moving vehicle such as a car or golf cart or in any object, or performing any operation. The movement of the vehicle machinery being operated may be the cause of some or all of the noise and/or may be the cause of the high winds, which in turn cause the noise. The cupped area may also be useful in various environments having extreme weather conditions (whether or not there are high winds), such as in heavy rains, sleet, snow, ice storms, thunderstorms and/or electrical storms.

### Alternatives and Extensions

Although a two-way radio is used as an example, a one-way radio or other device that emits sound may be used instead. In other embodiments having a casing for the radio, instead of the opening to the casing being on the bottom side of the casing, the opening to the body is elsewhere, such as at the top of the body of the casing, the back of the body of the casing, the front of the body of the casing, and/or the side of the body of the casing. In other embodiments, the amplifier attaches to other parts of the radio. In other embodiments, the arms are not present and the walls that form the cupped region may be strapped onto the body of the radio instead of being held unto the radio by the arms. In another embodiment, the cupped region may be screwed onto the radio. In other embodiments, the conduit, which is formed by the walls of the cupped region, has other shapes, such as circular, conical, ovular, and/or elliptical. In other embodiments, the corners of the cupped region are not rounded.

Optionally, the cupped region may have a funnel shape. Optionally, the cupped region is angled to face the head of the user when the radio is worn on the operator's utility belt. Optionally, an electronic microphone is placed in the opening of the cupped region to amplify the sound of the radio as the sound exits the radio. In an embodiment, in which the radio is placed in an enclosure, the casing that forms the enclosure encloses at least the entire speaker. In an embodiment, the cupped region, has rubber edges to block out sounds when placed to the ear of the user, and is optionally contoured to fit over the ear of an average adult.

Optionally, the speaker and the microphone of the radio are in different locations and both align with a different set of slits in the casing of the radio, and the amplifier include two sets of walls forming two separate cupped regions—one cupped region aligns with the speaker of the radio and one aligns with the microphone.

In an embodiment, the amplification of the sound is set based on the normal expected environmental noise and the average Signal to Noise Ratio (SNR) hearing loss of the average worker in that environment, so that the user experiences an effective normal SNR (e.g., −6 db or −6 to −3 dB). In an embodiment, the volume of the amplified sound is set to or may equal (the average volume of the environment)+(the normal minimal SNR required for 50% recognition of words)−(SNR-hearing loss of the average user). The operator may be using an ear covering or ear plugs to protect the user's hearing from the loud noise and SNR hearing loss due to the ear plug or ear coverings need to be included in the SNR hearing loss. Thus, if the normal hearing loss of the average worker (including the combination of the user's or average user's biological hearing loss and the user's or average user's hearing loss due to wearing protective equipment) is −3 db of SNR, and if the average noise in the environment is 80 dB, then the volume of the amplified sound is set to between 80 dB−6 dB+3 dB=77 dB to 80 dB−3 dB+3 dB=80 dB. In other embodiments, the volume may be set higher to achieve a higher SNR and better word recognition. However, in an embodiment, the volume of the radio is not allowed to exceed a desired maximum, to protect the hearing of the user, depending on the urgency of the situation. For example, sounds as loud as 150 dB may cause ear drum rupture and therefore should be avoided (as rupturing the eardrum of the operator would likely be counterproductive no matter how urgent the need), and thus, in an embodiment, the amplified sound usually should never be more than 150 db. Whereas, exposure to noise above 70 dB may damage hearing after 8 hours of exposure and should therefore usually be avoided, and so, in an embodiment, the amplified sound should usually not be set to more than 70 db, unless necessary to avoid more serious bodily harm, whereas above 110 dB generally causes pain and therefore even if the seriousness of the need justifies the hearing loss, may nonetheless, not be tolerable by the user and therefore counterproductive, and so the amplified volume should usually be kept less than 110 db (note doubling the amplitude of the volume, by for example producing a sound of the same volume as the environmental noise increase the volume by about 0.3 dB, and so usually is not a concern unless the user is already operating in an environment that is on the threshold of what is tolerable).

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A device comprising:
walls forming a cupped area attached to a fastener that fastens onto a radio.

2. A method comprising:
causing sound to exit a speaker of a radio that is inside a casing that encloses at least the speaker of the radio;
directing the sound through openings in the casing; and
amplifying the sound exiting the openings.

3. A method comprising:
amplifying sound that exits a speaker of a radio.

4. The method of claim 3, the amplifying of the sound including at least concentrating the sound.
